(19) United States
(12) Patent Application Publication
(10) Pub. No.: US 2024/0339256 A1
(43) Pub. Date: Oct. 10, 2024

(54) SOFT SATURATING INDUCTOR AND ASSOCIATED METHODS

(71) Applicant: ABB Schweiz AG, Baden (CH)

(72) Inventors: Dorai Yelaverthi, Raleigh, NC (US); Harish Suryanarayana, Raleigh, NC (US); Arun Kadavelugu, Raleigh, NC (US)

(21) Appl. No.: 18/297,292

(22) Filed: Apr. 7, 2023

(51) Int. Cl. H01F 27/26; H01F 27/28; H01F 41/02; H01F 41/04

(52) U.S. Cl. CPC H01F 27/26; H01F 27/28; H01F 41/0206; H01F 41/04

(57) ABSTRACT

A device includes a core structure including a first end plate and a second end plate. The first end plate and second end plate include a first portion and a second portion that extend from opposing sides of a third portion and include an increasing cross-sectional area configured to provide soft saturation properties in response to increasing electrical current. The core structure may further include a coil member and a core section. The core section is disposed between the first plate member and second plate member. The core section includes a first core member, a second core member, and a central disc member. The core section also includes a channel formed between the central disc member and the first core member and the second core member to enable the coil member to circumferentially wind around the central disc member.

### FIELD

The present disclosure relates to the field of electronic components and, more particularly, to soft saturating inductors.

### BACKGROUND

Inductive devices are widely used in electronic applications such as, for example, in uninterruptible power supplies or other applications. Optimally, inductive devices demonstrate high inductance at low current and low inductance at high current. Further, many applications require inductive devices to be capable of withstanding an overload capacity that is two to three times normal capacity for a specific duration. To be able to withstand overload, many applications utilize soft saturating inductive devices where the inductance decreases gradually as current increases rather than an inductive device where the inductance decreases abruptly in response to increasing current. However, this limits the choice of magnetic materials for use in inductive devices or may require additional manufacturing and design steps to produce a soft-saturating inductive device.

### SUMMARY

In some embodiments, an inductive device includes a core structure including a first end plate located at a first side, and a second end plate located at a second side of the core structure opposite the first side, the first end plate and the second end plate include a first portion and a second portion that extend from opposing sides of a third portion, the first portion and the second portion including a cross-sectional area that increases from the third portion and towards distal ends of the first portion and second portion, and the increasing cross-sectional area of the first portion and the second portion is configured to provide soft saturation properties in response to increasing current.

In some embodiments, the core structure further includes a central core layer disposed between the first end plate and the second end plate, the central core layer including a first core member, a second core member, and a central disc member located between the first core member and the second core member, and the central core layer includes a channel formed between the central disc member and each of the first core member and the second core member.

In some embodiments, the inductive device further includes a coil member located between the first end plate and the second end plate, the coil member circumferentially winds around the central disc member between the first end plate and the second end plate.

In some embodiments, the increasing cross-sectional area is in a direction that is substantially parallel to a direction of a magnetic flux which traverses a plane of the first end plate and the second end plate.

In some embodiments, a direction of an air gap is perpendicular to a plane of the first end plate and the second end plate; wherein the core structure does not include a decreasing cross-sectional area near the air gap.

In some embodiments, the core structure includes a high permeability magnetic material having abrupt saturation characteristics in response to an increasing magnetic field from an electrical current.

In some embodiments, the core structure includes an abrupt saturating magnetic material including at least one of: ferrite, magnetic steel, nickel, cobalt, alloys thereof, or any combinations thereof.

In some embodiments, a dimension of the third portion is configured to determine a saturation initiation point.

In some embodiments, the first portion and second portion extend from the third portion by an angle configured to provide the increasing cross-sectional area of the first portion and the second portion.

In some embodiments, a planar thickness of the first portion and second portion on the first end plate and the second end plate increases from the third portion towards the distal ends of the first portion and second portion.

In some embodiments, a method includes obtaining a high permeability magnetic material to form a core structure for an inductive device, forming a first end plate and a second end plate, wherein the first end plate and the second end plate include a first portion and a second portion that extend from opposing sides of a third portion, the first portion and the second portion including a cross-sectional area that increases from the third portion and towards distal ends of the first portion and second portion, arranging the first end plate at a first side of the core structure and the second end plate at a second side of the core structure opposite the first end plate, and arranging a coil member between the first end plate and the second end plate, wherein the increasing cross-sectional area of the first portion and the second portion is configured to provide soft saturation properties in response to increasing current.

In some embodiments, the method further includes forming one or more central core layers, and arranging the one or more central core layers between the first end plate and the second end plate; wherein the coil member extends through a channel formed at each of the one or more central core layers.

In some embodiments, each of the one or more central core layers includes a first core member, a second core member, and a central disc member located between the first core member and the second core member, the one or more central core layers includes a channel formed between the central disc member and each of the first core member and the second core member to enable the coil member to circumferentially wind around the central disc member.

In some embodiments, a width of the third portion is configured to determine a saturation initiation point.

In some embodiments, a planar thickness of the first portion and second portion increases from the third portion towards the distal ends of the first portion and second portion.

In some embodiments, an assembly includes an inductive device including a core structure, the core structure including a first end plate located at a first side, a second end plate located at a second side opposite the first side, and one or more central core layers located between the first end plate and the second end plate, a coil member, the first end plate and the second end plate include a first portion and a second portion that extend from opposing sides of a third portion, the first portion and the second portion including a cross-sectional area that increases from the third portion and towards distal ends of the first portion and second portion, and the increasing cross-sectional area of the first portion and the second portion is configured to provide soft saturation properties in response to increasing current, and the coil member extends through the one or more central core layer from the first side towards the second side.

In some embodiments, the increasing cross-sectional area is in a direction that is substantially parallel to a direction of a magnetic flux which traverses a plane of the first end plate and the second end plate, and the core structure does not include a decreasing cross-sectional area near an air gap structure.

In some embodiments, the core structure includes a high permeability magnetic material having abrupt saturation characteristics in response to an increasing magnetic field from an electrical current.

In some embodiments, each of the one or more central core layers further includes: a first core member, a second core member, and a central disc member located between the first core member and the second core member, the one or more central core layers includes a channel formed between the central disc member and each of the first core member and the second core member to enable the coil member to circumferentially wind around the central disc member.

In some embodiments, a planar thickness of the first portion and second portion increases from the third portion towards the distal ends of the first portion and second portion.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a perspective view of a non-limiting example of a device, according to some embodiments.

FIG. 2 is a side view of the device, according to some embodiments.

FIG. 3 is a perspective view of the end plates, according to some embodiments.

FIG. 4 is a top view of the end plates, according to some embodiments.

FIG. 5 is a top sectional view of the device, according to some embodiments.

FIG. 6 is a top view of the core section, according to some embodiments.

FIG. 7 is a side view of an end plate, according to some embodiments.

FIG. 8 is a flow diagram for a method, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

All prior patents and publications referenced herein are incorporated by reference in their entireties.

Inductors may be made of materials including ferrite, magnetic steel, powder core material(s), nickel, cobalt, alloys thereof, and other magnetic materials. Typically, soft saturating inductive devices are composed of powder core materials, such as iron powder or carbonyl powder, which can naturally achieve soft saturation. Alternatively, inductive devices using abrupt saturating materials, such as ferrite, implement designs of the core structure having reduced cross-sectional areas of the magnetic material inside the core or around the airgap. These core structures typically utilize designs where a cross-sectional area of the core structure at the air gap decreases, either gradually or in steps, to produce an inductive device capable of withstanding increasing levels of electrical current without a sudden drop-off in inductance during operation. Stated another way, these inductive devices design the core structure at or near the airgap that runs parallel to a direction of the magnetic flux.

Various embodiments described herein relate to a device, system, or assembly configured to oppose sudden changes in current through inductance. For example, an inductor for power converter systems. The devices described herein are capable of withstanding overcurrent conditions (e.g., 2 to 5 times normal capacity) using magnetic materials having high permeability and abrupt saturating properties such as, for example, ferrite or magnetic stainless steel. Additionally, the devices described herein include core structure designs where the operating characteristics of the device are controlled by increasing a cross-sectional area σ of the core structure that runs perpendicular to a magnetic flux that traverses the core structure rather than by designing the airgap structure to achieve soft saturating properties. Therefore, the devices described herein are capable of high inductance at low current and low inductance at high current without designing an air gap structure to achieve soft saturating properties in the inductive device capable of gradually decreasing inductance in response to increasing electrical current.

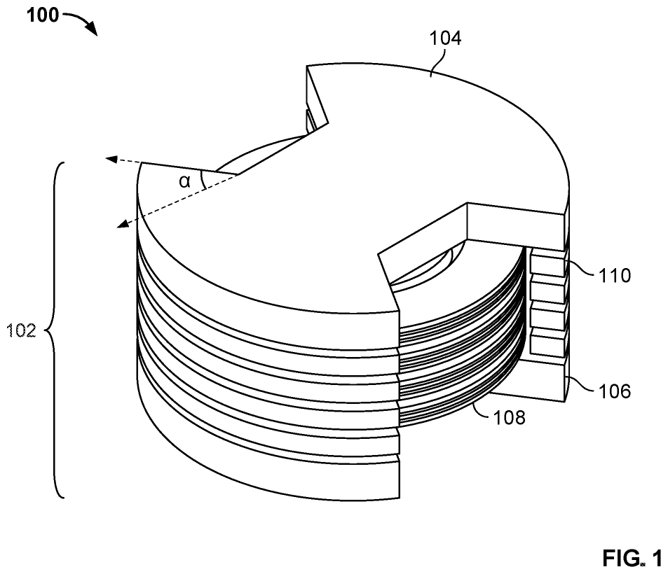

FIG. 1 illustrates a perspective view of a non-limiting example of a device 100, according to some embodiments. The device 100 includes a core structure 102. The core structure 102 may include a first end plate 104 located at a first side of core structure 102 and a second end plate 106 located at a second side of core structure 102 opposite the first side. In some embodiments, the core structure 102 may include a cavity defined, at least in part, by the first end plate 104 and the second end plate 106. The core structure 102 may also include a central core layer 110 located between the first end plate 104 and second end plate 106. In some embodiments, the core structure 102 may include a plurality of the central core layer 110 located between the first end plate 104 and second end plate 106. For example, the core structure 102 may include four layers between the first end plate 104 and second end plate 106 formed from the central core layer 110.

In core structure 102, the first end plate 104 and second end plate 106 are arranged at a first side and second side, respectively, of device 100 and the end plates, e.g., first end plate 104 and second end plate 106, may form part of a magnetic core structure that concentrates and contains the magnetic flux produced in response to electric current passing through coil member 108. The core structure 102 may be composed of abrupt saturating magnetic materials. However, the design of the core structure 102, e.g., increasing cross-sectional area σ of the first portion 112 and second portion 114, for example, enables the device 100 to provide soft saturation operating characteristics while being formed of abrupt saturating materials compared to inductive devices formed from soft saturating materials. In some embodiments, the core structure 102 may be composed of high permeability magnetic materials having abrupt saturation characteristics in response to electrical current increasing beyond a threshold limit.

As used herein, “abrupt saturation characteristics” refers to magnetic materials for inductive devices that are capable of high inductance at a lower electrical current (e.g., approximately 100 A) and that demonstrates an abrupt drop-off in inductance in response to increasing electrical current increasing over a certain threshold or current range (e.g., from 200 A to 500 A). It is to be appreciated by those having skill in the art that the electrical current and impedance values of the magnetic materials that form the core structure 102 are not intended to be limiting and the values may therefore include any of a plurality of electrical current and impedance values corresponding to soft saturation characteristics and a gradual decrease in inductance in response to increasing electrical current, in accordance with this disclosure.

In some embodiments, the core structure 102 may be composed of abrupt saturating magnetic material including at least one of: ferrites, magnetic steel, nickel, cobalt, alloys thereof, or other like core materials having high permeability and susceptible to abrupt saturation in response to increasing electrical current (absent an air gap), or any combinations thereof that are susceptible to a sudden drop-off in inductance in response to electrical current exceeding a certain threshold. In some embodiments, the core structure 102 may comprise essentially of ferrite and/or magnetic steel. In some embodiments, the core structure 102 may comprises essentially of ferrite. In other embodiments, the core structure 102 may comprise essentially of magnetic steel. In some embodiments, the core structure 102 may consist essentially of ferrite and/or magnetic steel. In some embodiments, the core structure 102 may consist essentially of ferrite. In other embodiments, the core structure 102 may consist essentially of magnetic steel. It is to be appreciated by those having ordinary skill in the art that the shape of the core structure 102 is not intended to be limiting and may include any of a plurality of shapes including, but not limited to, PM core, PQ core, RM core, other core shapes, or any combinations thereof in accordance with this disclosure. For example, the core structure 102 may resemble a PM core structure.

The core structure 102 may also include a central core layer 110 located between first end plate 104 and second end plate 106. In some embodiments, the core structure 102 may include at least one of the central core layer 110 located between the first end plate 104 and second end plate 106. In other embodiments, the core structure 102 may include one or more of the central core layer 110 vertically stacked between the first end plate 104 and second end plate 106. In some embodiments, each of the central core layer 110 may be arranged such that the first end plate 104, second end plate 106, and each of the central core layer 110 located therebetween may be in substantially colinear alignment to enable the device 100 to concentrate the magnetic flux based on a desired operating characteristic of the device 100.

In some embodiments, an outer profile of the central core layer 110 may be similar to the outer profile of the first end plate 104 and second end plate 106, as will be further described herein. In some embodiments, the central core layer 110 may define an opening (e.g., channel 126) which circumferentially extends through the central core layer 110 and through which the coil member 108 may be wound. In some embodiments, the central core layer 110 may include a circumferential shaped disc or plate.

In some embodiments, the central core layer 110 may also be composed of high permeability magnetic materials capable of abrupt saturation. Accordingly, in some embodiments, the central core layer 110 may also be composed of abrupt saturating magnetic materials including at least one of ferrites, magnetic steel, nickel, cobalt, alloys thereof, other like core materials capable of abrupt saturation in response to increasing current, or any combinations thereof, and which may be susceptible to a sudden drop-off in inductance in response to increasing current. In some embodiments, the central core layer 110 may comprise ferrite, magnetic steel, or both. In some embodiments, the central core layer 110 may comprise essentially of ferrite. In some embodiments, the central core layer 110 may comprise essentially of magnetic steel. In some embodiments, the central core layer 110 may consist essentially of ferrite. In other embodiments, the central core layer 110 may consist essentially of magnetic steel. In some embodiments, the central core layer 110 may be composed of essentially the same material as the first end plate 104 and second end plate 106. In other embodiments, the materials that form the central core layer 110 may be based on a desired magnetic flux characteristics of the device 100.

Similarly, the materials that form the layers of the core structure 102 may also be based on a desired magnetic flux characteristics of the device 100. It is to be appreciated by those having ordinary skill in the art that the number of layers in the device 100 such as, for example, the number of the central core layer 110 included in device 100 is not intended to be limiting and may include any number of layers based on a desired inductance or other electromagnetic properties of the device 100, in accordance with this disclosure. For example, the device 100 may include one, two, three, four, or more layers of central core layer 110 arranged between the first end plate 104 and second end plate 106.

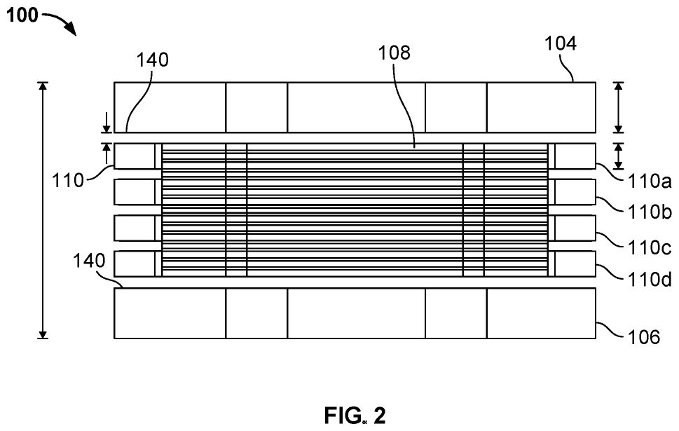

As shown in FIG. 1, in some embodiments, the first end plate 104 and second end plate 106 may include an outer profile that corresponds to the other of the first end plate 104 and second end plate 106 of device 100. Additionally, in some embodiments, the central core layer 110 may be configured to substantially conform to the outer profile of the first end plate 104, second end plate 106, or both. In other embodiments, the central core layer 110 may define an outer profile that is distinctive from the first end plate 104 and second end plate 106 but where the members of the central core layer 110 may be arranged between the first end plate 104 and the second end plate 106 to enable the central core layer 110 to be in colinearly aligned with the first end plate 104 and second end plate 106 as shown in FIG. 1. In some embodiments, the outer profile of the central core layer 110 may be based on a profile of the first end plate 104, the second end plate 106, or both. As used herein, the term “outer profile” refers to a profile defined by the device 100 as viewed from a top of the device 100, as shown in FIG. 4, as opposed to a side view of the device 100 such as shown in, for example, FIG. 2.

The device 100 may also include a coil member 108 that extends between the first end plate 104 and second end plate 106 and through the central core layer 110, as will be further described herein. Coil member 108 is an elongated coil made of electrically conductive material having a first end and a second end, each end in electrical connection with a power source or some other component capable of passing an electrical current through coil member 108. Coil member 108 is configured to receive an electrical current and generate an electromagnetic field in response to the current. In some embodiments, coil member 108 may be a rounded conductor. In other embodiments, coil member 108 may be substantially flat. It is to be appreciated by those having ordinary skill in the art that the shape of coil member 108 is not intended to be limiting and may include any of a plurality of other shapes or features in accordance with this disclosure. It is to be appreciated by those having ordinary skill in the art that the material of coil member 108 is not intended to be limiting and may include any of a plurality of materials in accordance with this disclosure capable of passing a current through coil member 108 to enable an electromagnetic field to be generated in accordance with this disclosure.

In some embodiments, the coil member 108 may be circumferentially wound into a coil or spiral in the cavity (e.g., channel 126), where a first end of coil member 108 is adjacent the first side of the device 100 and the second end of the coil member 108 is adjacent the second side of device 100. The first end and second end of the coil member 108 may be placed in electrical connection with a power source or other electrical component capable of directing an electrical current through coil member 108. In some embodiments, coil member 108 may be wound around a central disc member 122 of the central core layer 110, as will be further described herein. It is to be appreciated by those having ordinary skill in the art that the number of turns of the coil member 108 is not intended to be limiting and may include any number of turns based on a desired electrical characteristics of the device 100, in accordance with this disclosure.

FIG. 2 illustrates a side view of the device 100, according to some embodiments. The core structure 102 includes a first end plate 104 at a first side of device 100 and a second end plate 106 at a second side of device 100 opposite the first end plate 104. Additionally, in some embodiments, the core structure 102 may include one or more core sections located between the first end plate 104 and second end plate 106, thereby forming a plurality of core layers. As shown in FIG. 2, the device 100 includes central core layer 110a, central core layer 110b, central core layer 110c, and central core layer 110d in a vertically stacked arrangement between the first end plate 104 and second end plate 106. Additionally, in some embodiments, the device 100 may include a coil member 108 located between the first end plate 104 and second end plate 106 that is circumferentially wound through each channel 126 formed at central core layer 110a, central core layer 110b, central core layer 110c, and central core layer 110d. It is to be appreciated by those having ordinary skill in the art that the number of core sections between the first end plate 104 and second end plate 106 is not intended to be limiting and the device 100 may include fewer or more core sections in accordance with this disclosure.

In some embodiments, the first end plate 104, second end plate 106, and each of the central core layer 110 may include any of a plurality of dimensions based on a desired operational performance of the device 100, in accordance with this disclosure. In some embodiments, the first end plate 104, the second end plate 106, the central core layer 110, or any combination thereof may be designed and fabricated during manufacturing based on the desired operational characteristics of the device 100. For example, in some embodiments, the dimensions of the device 100 may be dependent on an optimal magnetic flux density, inductance in response to increasing electrical current (e.g., overcurrent conditions), other characteristics, or any combinations thereof. Accordingly, in some embodiments, the dimensions (e.g., length, width, height, etc.) of the first end plate 104, second end plate 106, each central core layer 110 arranged therebetween, or any portions thereof may be based on the desired operational characteristics of the device 100 in accordance with this disclosure.

The height (e.g., layer thickness) of the first end plate 104 and second end plate 106 may be configured based on the desired operational characteristics of device 100. Each layer of the central core layer 110 located therebetween the first end plate 104 and the second end plate 106 may also be configured based on the desired operational characteristics of the device 100. The first end plate 104 may be a first height and the second end plate 106 may be a second height. In some embodiments, the first height may be the same height as the second height. In some embodiments, the first height may be substantially similar to the second height. In other embodiments, the first height may be a different height than the second height. The central core layer 110 may be a third height. In some embodiments, the third height may be substantially similar to the first height, the second height, or both. In some embodiments, the third height may be a different height than the first height, the second height, or both. For example, the first end plate 104 and the second end plate 106 may each have a height of 12 mm and the central core layer 110 may have a height of 6 mm. In some embodiments, the height of each central core layer 110 in the core structure 102 may be the same. In other embodiments, the height of the central core layer 110 may be substantially similar height. In some embodiments, the height of each one of the central core layer 110 may vary based on the desired operational characteristics of the device 100.

The device 100 may also include an air gap 140. In some embodiments, the device 100 may include one or more air gaps 140 formed between each core layer. For example, each air gap 140 located between each core layer may have a distance of 2.5 mm. In some embodiments, the device 100 may include a first air gap located between the first end plate 104 and the central core layer 110 adjacent the first side and a second air gap located between the second end plate 106 and the central core layer 110 adjacent the second side of device 100. In some embodiments, the device 100 may also include an air gap 140 located between each central core layer 110. In some embodiments, a height of each one of the air gap 140 located between each core layer may be a uniform distance across the width of device 100. In some embodiments, the device 100 may include a plurality of air gaps 140 where adjacent core layers include an air gap 140 formed therebetween the respective core layers and each air gap 140 having a uniform distance across a width of device 100.

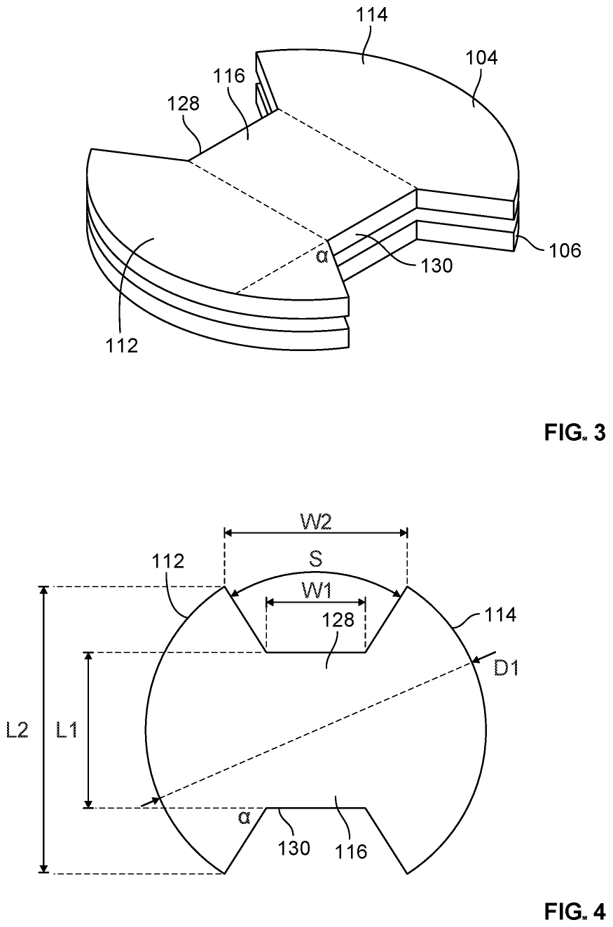

FIG. 3 illustrates a perspective view of an example first end plate 104 and second end plate 106, according to some embodiments. FIG. 4 illustrates a top view of an example first end plate 104 or second end plate 106, according to some embodiments.

Each of the first end plate 104 and second end plate 106 include a first portion 112, a second portion 114, and a third portion 116 located between the first portion 112 and the second portion 114. Accordingly, the second portion 114 is located opposite from the first portion 112 at the third portion 116. In some embodiments, each of the first end plate 104 and second end plate 106 may each include a body that is continuously formed from the first portion 112, second portion 114, and third portion 116.

The first portion 112 and second portion 114 extend from opposing ends of the third portion 116. Additionally, first portion 112 and second portion 114 include a cross-sectional area σ that gradually increases as the first portion 112 and second portion 114 extend from third portion 116 towards a distal end of the first end plate 104 and second end plate 106. In some embodiments, a distal end of the first portion 112 and second portion 114 may include an arcuate shape (e.g., convex). In other embodiments, the distal end of the first portion 112 and second portion 114 may be substantially linear (e.g., flat). In other embodiments, the distal end of the first portion 112 and second portion 114 may include other shapes such as, for example, polygonal, concave, convex, other shapes, or any combinations thereof.

The third portion 116 is located between the first portion 112 and second portion 114. The third portion 116 is configured to determine a saturation initiation point of the core structure 102. Accordingly, the dimensions of the third portion 116 may be configured based on a desired saturation initiation point for the device 100. In some embodiments, the third portion 116 may include a square shape or rectangular shape defined, at least in part, by side 128 and side 130 that extend between the first portion 112 and second portion 114 and which defines the third portion 116 along with the sides common with the first portion 112 and the second portion 114. In some embodiments, side 128 and side 130 may be substantially parallel. In other embodiments, side 128 and side 130 that extend between the first portion 112 and the second portion 114 may be asymmetrical with respect to each other. In other embodiments, side 128 and side 130 may be non-linear. For example, side 128 and side 130 may be arcuate (e.g., concave or convex), polygonal, other shapes, or any combinations thereof. In some embodiments, the third portion 116 may include any of a plurality of shapes and/or dimensions based on one or more desired electromagnetic properties such as, for example, the magnetic flux density of the device 100.

The dimensions of the device 100, e.g., first end plate 104, second end plate 106, and central core layer 110, may be configured to provide certain operational characteristics, such as magnetic flux density and inductance value in response to increasing electrical current. In some embodiments, the operational characteristics of the device 100 may be configured based on the angle α by which the first portion 112 and second portion 114 extend from the third portion 116 and the gradually increasing cross-sectional area σ of the first portion 112 and the second portion 114 at each end plate member, e.g., the first end plate 104 and second end plate 106.

Accordingly, the operational characteristics of the device 100 may be configured based on increasing a cross-sectional area σ of the first end plate 104 and second end plate 106 in a direction that is substantially parallel to a direction the magnetic flux traverses the core layer of the first end plate 104 and the second end plate 106. The increasing cross-sectional area σ of the first end plate 104 and second end plate 106 thereby enables the device 100 to achieve soft saturation rather than by designing the structure of the core structure 102 around the air gap 140 to controls the saturation characteristics of the device 100. Stated another way, in some embodiments, the core structure 102 (e.g., each core layer) of the device 100 is fabricated to not include an increasing/decreasing cross-sectional area adjacent the airgap between the core layers.

Referring to FIG. 4, the first portion 112 and second portion 114 may extend from the third portion 116 by an increasing cross-sectional area σ defined by the first portion 112 and second portion 114. In some embodiments, the first portion 112 and second portion 114 may angularly extend from the third portion 116 by an angle α that results in the increasing cross-sectional area σ defined by the first portion 112 and second portion 114. In this regard, the rate at which the cross-sectional area σ of the first portion 112 and the second portion 114 increases is directly proportional to the angle α by which the first portion 112 and second portion 114 extend from the third portion 116. Accordingly, as shown in FIG. 4, the sides of the first portion 112 and second portion 114 extend from side 128 or side 130 of the third portion 116 by an angle α, respectively. For example, the first end plate 104 and second end plate 106 may extend from the third portion 116 by an angle of 57.5° from the plane formed by side 128 or side 130 of third portion 116. The angle α by which the first portion 112 and second portion 114 increases, and results in the increasing cross-sectional area σ of the first portion 112 and second portion 114, may be determined based on the desired electromagnetic properties of the device 100.

Accordingly, the angle α may be configured based on the desired operational characteristics of the device 100. For example, based on a desired magnetic flux density of the device 100. In some embodiments, the angle α may be between 0° and 145°, or any range or subrange therebetween. In some embodiments, the angle α may be between 5° and 90°. In some embodiments, the angle α may be between 5° and 85°. In some embodiments, the angle α may be between 5° and 80°. In some embodiments, the angle α may be between 5° and 75°. In some embodiments, the angle α may be between 5° and 70°. In some embodiments, the angle α may be between 5° and 60°. In some embodiments, the angle α may be between 10° and 90°. In some embodiments, the angle α may be between 10° and 85°. In some embodiments, the angle α may be between 10° and 80°. In some embodiments, the angle α may be between 10° and 75°. In some embodiments, the angle α may be between 10° and 70°. In some embodiments, the angle α may be between 10° and 60°. In some embodiments, the angle α may be between 15° and 90°. In some embodiments, the angle α may be between 15° and 85°. In some embodiments, the angle α may be between 15° and 80°. In some embodiments, the angle α may be between 15° and 75°. In some embodiments, the angle α may be between 15° and 70°. In some embodiments, the angle α may be between 15° and 60°. In some embodiments, the angle α may be between 25° and 90°. In some embodiments, the angle α may be between 25° and 85°. In some embodiments, the angle α may be between 25° and 80°. In some embodiments, the angle α may be between 25° and 75°. In some embodiments, the angle α may be between 25° and 70°. In some embodiments, the angle α may be between 25° and 60°. It is to be appreciated by those having ordinary skill in the art that the angle α is not intended to be limiting and may include any of a plurality of angles in accordance with this disclosure.

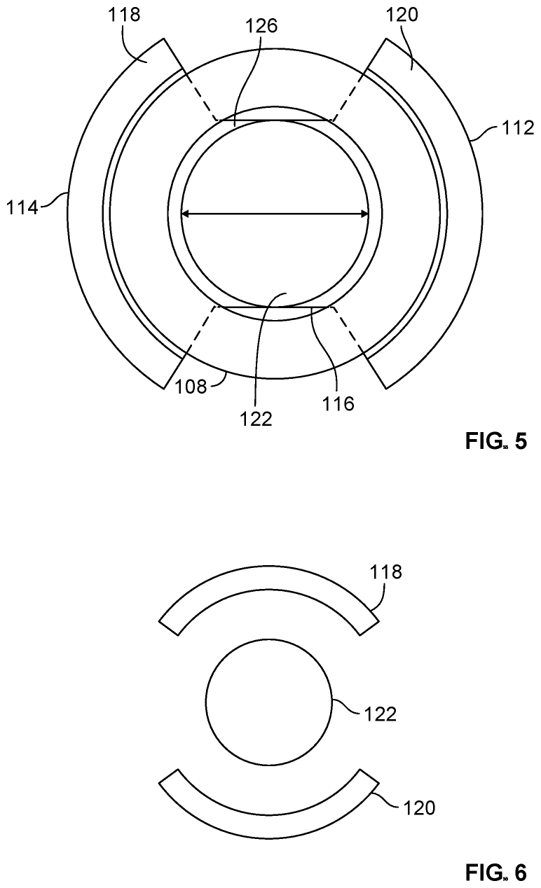

In some embodiments, each of the first end plate 104 and second end plate 106 may include a diameter D1. The diameter D1 may be a distance between a distal end of first portion 112 and a distal end of second portion 114 opposite the third portion 116 and the distal end of first portion 112. Accordingly, the diameter D1 may be a total diameter of the first end plate 104 and second end plate 106. Additionally, in some embodiments, the location of the central core layer 110, or the components thereof, may be based on the diameter D1. For example, a distance between the ends of first core member 118 and second core member 120, as shown in FIG. 5, may be determined based on the distance of diameter D1. In some embodiments, the third portion 116 may include a length L1. The length L1 of the third portion 116 may determine the saturation initiation point of the core structure 102 in response to an electromagnetic field. Additionally, the third portion 116 may include a width W1 that extends between the first portion 112 and second portion 114. Accordingly, the third portion 116 may be defined by an area formed from sides having dimensions corresponding to L1 and W1.

In some embodiments, the first portion 112 and second portion 114 may extend from opposite ends of third portion 116 by angle α such that the cross-sectional area σ of the first portion 112 and second portion 114 increases as the first portion 112 and second portion 114 extends from the third portion 116 towards distal ends of the first end plate 104 and second end plate 106, respectively. Further, the first portion 112 and second portion 114 may extend from the third portion 116 by a width W2, thereby forming an arc segment of S degrees between the first portion 112 and second portion 114. Accordingly, in some embodiments, the first end plate 104 and second end plate 106 may include a profile corresponding to having a first disc cutout segment and second disc cutout segment removed from the first end plate 104 and second end plate 106 at opposing sides of the third portion 116 (e.g., at side 128 and side 130), the disc cutout segments having an arc segment of S degrees. For example, the first end plate 104 and second end plate 106 may have a diameter (D1) of 114 mm, the third portion 116 may have a length (L1) of 32 mm and width (W1) of 33.13 mm, each of the first portion 112 and second portion 114 may have a length (L2) of 96.15 mm and extend from the third portion 116 with an increasing cross-sectional area and having a width (W2) therebetween of 61.25 mm and forming an arc segment(S) therebetween of 65°.

The profile of the first end plate 104 and second end plate 106 may be configured to concentrate the magnetic flux at the core structure 102 rather than by manipulating the structure of the core structure 102 at the airgap. Accordingly, the first end plate 104 and second end plate 106 may include a first portion 112 and second portion 114 having an increasing cross-section area σ to provide a gradually increasing flux path in response to an increasing electromagnetic field. This results in a gradual (e.g., “slow”) saturation of the magnetic material where the magnetic flux density may be higher in the narrow portions (e.g., by the third portion 116) and the magnetic flux density may be lower in the wider portions (e.g., near the distal ends of the first end plate 104 and second end plate 106). Additionally, in some embodiments, the arrangement of each of the central core layer 110 may be based on the shape and dimensions of the first end plate 104 and second end plate 106, as will be further described herein.

FIG. 5 illustrates a top sectional view of the device 100, according to some embodiments. FIG. 6 illustrates a top view of the central core layer 110, according to some embodiments. Unless specifically referenced, FIGS. 5-6 will be described collectively.

The device 100 includes one or more central core layer 110 arranged between the first end plate 104 and second end plate 106. The one or more central core layer 110 may be disposed in a vertically stacked arrangement between the first end plate 104 and second end plate 106. Additionally, the central core layer 110 may include a first core member 118, a second core member 120, and a central disc member 122 arranged between the first core member 118 and the second core member 120. Accordingly, the first core member 118 and the second core member 120 are oppositely arranged relative to the central disc member 122.

Additionally, as shown in FIG. 5, the first core member 118 and the second core member 120 may be spaced apart from the central disc member 122 forming channel 126 therebetween. When device 100 includes multiple central core layer 110 in a vertically stacked arrangement, the channel 126 of each central core layer 110 in the vertically stacked arrangement join together in colinear alignment and forms a circumferentially shaped cavity therein. The interior of the cavity is defined by the central disc member 122 and an exterior wall of the cavity is defined, at least in part, by the first core member 118 and the second core member 120.

When the first end plate 104 and the second end plate 106 are arranged at opposite sides of the vertically stacked arrangement of central core layer 110, the cavity may also be defined, in part, by the first end plate 104 and second end plate 106 respectively. Furthermore, the coil member 108 may be arranged in the cavity defined therein. The coil member 108 may circumferentially wind through the cavity around the central disc member 122 and extending between the first end plate 104 and second end plate 106 from a first side to a second side of the device 100.

In some embodiments, the central core layer 110 may include a central disc member 122 centrally located at each central core layer 110. In other embodiments, the central disc members 122 arranged between the first end plate 104 and second end plate 106 may form a single integrally formed core member that extends between the first end plate 104 and second end plate 106 of the device 100. In some embodiments, the central disc members 122 located between the first end plate 104 and second end plate 106 may include an air gap 140 formed between one or more of the central disc members 122 of the device 100. For example, the device 100 may include one or more spacers between each one of the central disc members 122, thereby providing an air gap 140 between the central disc members 122. In some embodiments, the layer or layers of the core structure 102 may be separated by one or more air gap 140.

Although not shown in the figures, in some embodiments, the air gap 140 may be provided by a spacer arranged between the layers. In some embodiments, one or more of the layers of the core structure 102 (e.g., the first end plate 104, second end plate 106, central core layer 110, or combinations thereof) may include one or more spacers integrally formed between each layer. For example, the central core layer 110 may include one or more embossments formed on a first side, second side, or both sides of the central core layer 110 to provide the air gap 140. In some embodiments, the spacer may be formed of a magnetic material. In other embodiments, the spacer may be formed of a non-magnetic material.

In some embodiments, the shape of the first core member 118 and the second core member 120 may conform to the shape of the first portion 112 and the second portion 114. For example, as shown in FIG. 5, the first core member 118 and the second core member 120 include an arcuate shape that substantially conforms to the arcuate shape of the distal ends of the first end plate 104 and second end plate 106 and, more particularly, the distal ends of the first portion 112 and the second portion 114 of the first end plate 104 and second end plate 106. This enables the central core layer 110 to be arranged between the first end plate 104 and second end plate 106 and in colinear alignment with the first end plate 104 and second end plate 106. In other embodiments, the distal ends of the first portion 112 and second portion 114 may be linear (e.g., straight) and the first core member 118 and the second core member 120 may also be linear segments to enable the central core layer 110 to be arranged between the first end plate 104 and second end plate 106 and in colinear alignment with the first end plate 104 and second end plate 106. It is to be appreciated by those having ordinary skill in the art that the first core member 118, the second core member 120, the central disc member 122, or any portions thereof may include any of a plurality of shapes including, but not limited to linear, curved, arcuate, polygonal, concave, convex, other shapes, or any combinations thereof, in accordance with this disclosure. In this regard, in some embodiments, the shapes of the first core member 118 and the second core member 120 may not be dependent on the shape or profile of the first end plate 104 and second end plate 106. For example, the distal ends of the first end plate 104 and second end plate 106 may be arcuate and the first core member 118 and the second core member 120 may be linear segments. In another embodiment, the sidewall of the central disc member 122 may include a plurality of sides.

In some embodiments, the central core layer 110 may include a channel 126 defined by the first core member 118 and the second core member 120 being arranged around the central disc member 122. The channel 126 circumferentially extends around the central disc member 122 and between each of the first core member 118 and the second core member 120. Accordingly, the members forming the central core layer 110 are arranged between the first end plate 104 and second end plate 106 to enable the coil member 108 to circumferentially wind through the channel 126 around the central disc member 122.

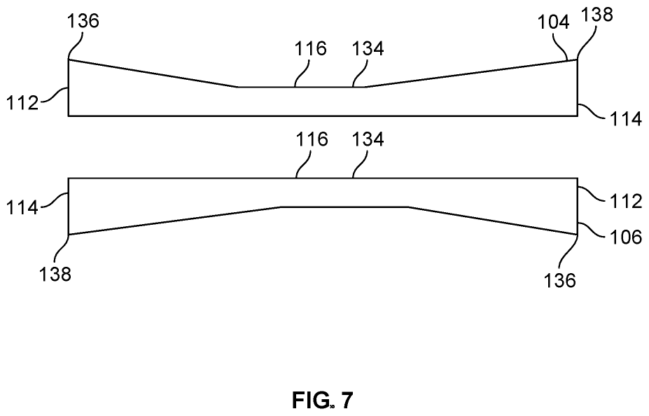

FIG. 7 illustrates a side view of an example embodiment of the first end plate 104 and second end plate 106, according to some embodiments. In some embodiments, the first end plate 104, second end plate 106, or both may include a consistent layer thickness (e.g., height) across the diameter of the core layer between distal ends of the first portion 112 and second portion 114. As shown in FIG. 7, in some embodiments, the first portion 112 and second portion 114 may each increase in height (e.g., thickness) as the first portion 112 and second portion 114 extend from the respective side common to the third portion 116 and towards a respective distal end of the first portion 112 and second portion 114. Therefore, the first portion 112 and second portion 114 may include an effective cross-sectional area σ that increases in a lateral direction, a vertical direction, or both to provide the soft saturation properties (e.g., gradual saturation characteristics) in response to increasing current. Accordingly, for the first end plate 104 and second end plate 106 arranged at opposite sides of the core structure 102, the first portion 112 and second portion 114 on each respective end plate gradually increases in height (e.g., thickness) in opposing directions as the first portion 112 and second portion 114 laterally extend towards their respective distal ends, while the inner facing sides of the first end plate 104 and second end plate 106, respective each other, are substantially planar.

In some embodiments, on the first end plate 104 and second end plate 106, the third portion 116 may be a height 134, the first portion 112 may be a height 136, and the second portion 114 may be a height 138. As shown in FIG. 7, the height of the first portion 112 and the second portion 114 gradually increases as the first portion 112 and second portion 114 extend from the third portion 116 and towards the respective distal ends. In some embodiments, each of the height 134, height 136, and height 138 may be substantially similar. In some embodiments, the height 136 and the height 138 may be greater than the height 134. In some embodiments, the height 136 may be greater than the height 134. In other embodiments, the height 138 may be greater than the height 134. In some embodiments, the height 136 and the height 138 located at a respective distal end of the first portion 112 and second portion 114 may be the same or substantially similar height. In other embodiments, the height 136 and the height 138 located at respective distal ends of the first portion 112 and second portion 114 may be different heights.

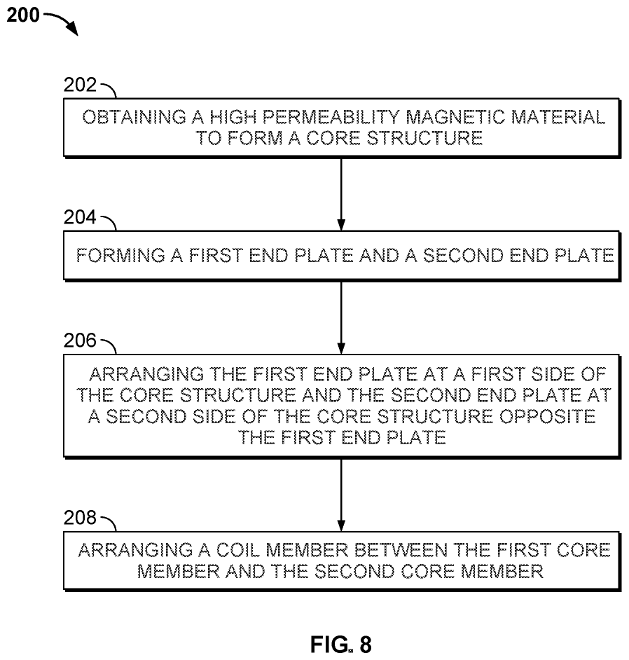

FIG. 8 illustrates a flow diagram for a method 200, according to some embodiments. At 202, the method 200 includes obtaining a high permeability magnetic material to form a core structure 102 for an inductive device. The magnetic material may include ferrite, magnetic stainless steel, nickel, cobalt, other materials capable of abrupt saturation, alloys thereof, or any combinations thereof.

At 204, the method 200 includes forming a first end plate 104 and a second end plate 106. In some embodiments, the first end plate 104 and the second end plate 106 include a first portion 112 and a second portion 114 that extend from opposing sides of a third portion 116, the first portion 112 and the second portion 114 including a cross-sectional area σ that increases from the third portion 116 and towards distal ends of the first portion 112 and second portion 114. In some embodiments, the increasing cross-sectional area σ of the first portion 112 and the second portion 114 is configured to provide soft saturation properties in response to increasing current. Additionally, in some embodiments, the first end plate 104 and the second end plate 106 may be formed such that a width of the third portion 116 is configured to determine a saturation initiation point for a magnetic flux concentrated at a core structure 102 of the inductive device as a result of an electrical current applied to the coil member 108. Furthermore, in some embodiments, a planar thickness of the first portion 112 and second portion 114 increases from the third portion 116 towards the distal ends of the first portion 112 and second portion 114. Accordingly, the first portion 112 and second portion 114 may include an effective cross-sectional area σ that increases in both a lateral and vertical direction to provide the soft saturation properties (e.g., gradual saturation characteristics) of an inductive device in response to increasing current.

At 206, the method 200 includes arranging the first end plate 104 at a first side of the core structure 102 and the second end plate 106 at a second side of the core structure 102 opposite the first end plate 104. In some embodiments, the first end plate 104 and second end plate 106 may include a uniform planar thickness. At 208, the method 200 includes arranging a coil member 108 between the first end plate 104 and the second end plate 106.

In some embodiments, the method 200 further includes forming one or more of a central core layer 110. In some embodiments, each of the one or more of the central core layer 110 includes a first core member 118, a second core member 120, and a central disc member 122 located between the first core member 118 and the second core member 120. The central core layer 110 may be in colinear alignment with each of the first end plate 104 and second end plate 106. Additionally, in some embodiments, the central disc member 122 may be centrally disposed between the first core member 118 and second core member 120, thereby forming a channel 126 between the central disc member 122 and each of the first core member 118 and second core member 120. Furthermore, in some embodiments, the coil member 108 may circumferentially wind around the central disc member 122 through the channel 126.

In some embodiments, the method 200 further includes arranging the one or more of the central core layer 110 between the first end plate 104 and the second end plate 106. In some embodiments, the device 100 may include a plurality of central core layer 110 arranged in a vertically stacked arrangement between the first end plate 104 and second end plate 106. In some embodiments, the coil member 108 extends through an opening (e.g., channel 126) of the one or more of the central core layer 110. In some embodiments, the coil member 108 extends circumferentially through the channel 126 and is wound around the central disc member 122 which forms a core that may extend between the first end plate 104 and second end plate 106.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

### ZOT—Definition Of Terms—Use As Needed

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “between” does not necessarily require being disposed directly next to other elements. Generally, this term means a configuration where something is sandwiched by two or more other things. At the same time, the term “between” can describe something that is directly next to two opposing things. Accordingly, in any one or more of the embodiments disclosed herein, a particular structural component being disposed between two other structural elements can be:
disposed directly between both of the two other structural elements such that the particular structural component is in direct contact with both of the two other structural elements;
disposed directly next to only one of the two other structural elements such that the particular structural component is in direct contact with only one of the two other structural elements;
disposed indirectly next to only one of the two other structural elements such that the particular structural component is not in direct contact with only one of the two other structural elements, and there is another element which juxtaposes the particular structural component and the one of the two other structural elements;
disposed indirectly between both of the two other structural elements such that the particular structural component is not in direct contact with both of the two other structural elements, and other features can be disposed therebetween; or any combination(s) thereof.

### Aspects

Various Aspects are described below. It is to be understood that any one or more

of the features recited in the following Aspect(s) can be combined with any one or more other Aspect(s).

Aspect 1. An inductive device comprising: a core structure comprising: a first end plate located at a first side, and a second end plate located at a second side of the core structure opposite the first side; and wherein the first end plate and the second end plate comprise a first portion and a second portion that extend from opposing sides of a third portion, the first portion and the second portion comprising a cross-sectional area that increases from the third portion and towards distal ends of the first portion and second portion; wherein the increasing cross-sectional area of the first portion and the second portion is configured to provide soft saturation properties in response to increasing current.

Aspect 2. The inductive device of aspect 1, wherein the core structure further comprises: a central core layer disposed between the first end plate and the second end plate, the central core layer comprising: a first core member, a second core member, and a central disc member located between the first core member and the second core member; wherein the central core layer comprises a channel formed between the central disc member and each of the first core member and the second core member.

Aspect 3. The inductive device according to any of the preceding aspects, further comprising: a coil member located between the first end plate and the second end plate, wherein the coil member circumferentially winds around the central disc member between the first end plate and the second end plate.

Aspect 4. The inductive device according to any of the preceding aspects, wherein the increasing cross-sectional area is in a direction that is substantially parallel to a direction of a magnetic flux which traverses a plane of the first end plate and the second end plate.

Aspect 5. The inductive device of aspect 4, wherein a direction of an air gap is perpendicular to a plane of the first end plate and the second end plate; wherein the core structure does not include a decreasing cross-sectional area near the air gap.

Aspect 6. The inductive device according to any of the preceding aspects, wherein the core structure comprises a high permeability magnetic material having abrupt saturation characteristics in response to an increasing magnetic field from an electrical current.

Aspect 7. The inductive device of aspect 6, wherein the core structure comprises an abrupt saturating magnetic material comprising at least one of: ferrite, magnetic steel, nickel, cobalt, alloys thereof, or any combinations thereof.

Aspect 8. The inductive device according to any of the preceding aspects, wherein a dimension of the third portion is configured to determine a saturation initiation point.

Aspect 9. The inductive device according to any of the preceding aspects, wherein the first portion and second portion extend from the third portion by an angle configured to provide the increasing cross-sectional area of the first portion and the second portion.

Aspect 10. The inductive device of aspect 9, wherein a planar thickness of the first portion and second portion on the first end plate and the second end plate increases from the third portion towards the distal ends of the first portion and second portion.

Aspect 11. A method comprising: obtaining a high permeability magnetic material to form a core structure for an inductive device; forming a first end plate and a second end plate, wherein the first end plate and the second end plate comprise a first portion and a second portion that extend from opposing sides of a third portion, the first portion and the second portion comprising a cross-sectional area that increases from the third portion and towards distal ends of the first portion and second portion; arranging the first end plate at a first side of the core structure and the second end plate at a second side of the core structure opposite the first end plate; and arranging a coil member between the first end plate and the second end plate; wherein the increasing cross-sectional area of the first portion and the second portion is configured to provide soft saturation properties in response to increasing current.

Aspect 12. The method of aspect 11, further comprising: forming one or more central core layers; and arranging the one or more central core layers between the first end plate and the second end plate; wherein the coil member extends through a channel formed at each of the one or more central core layers.

Aspect 13. The method according to any of the preceding aspects, wherein each of the one or more central core layers comprises: a first core member, a second core member, and a central disc member located between the first core member and the second core member; wherein the one or more central core layers comprises a channel formed between the central disc member and each of the first core member and the second core member to enable the coil member to circumferentially wind around the central disc member.

Aspect 14. The method according to any of the preceding aspects, wherein a width of the third portion is configured to determine a saturation initiation point.

Aspect 15. The method according to any of the preceding aspects, wherein a planar thickness of the first portion and second portion increases from the third portion towards the distal ends of the first portion and second portion.

Aspect 16. An assembly comprising: an inductive device comprising a core structure, the core structure comprising: a first end plate located at a first side, a second end plate located at a second side opposite the first side, and one or more central core layers located between the first end plate and the second end plate; a coil member; wherein the first end plate and the second end plate comprise a first portion and a second portion that extend from opposing sides of a third portion, the first portion and the second portion comprising a cross-sectional area that increases from the third portion and towards distal ends of the first portion and second portion; and wherein the increasing cross-sectional area of the first portion and the second portion is configured to provide soft saturation properties in response to increasing current; wherein the coil member extends through the one or more central core layer from the first side towards the second side.

Aspect 17. The assembly of aspect 16, wherein the increasing cross-sectional area is in a direction that is substantially parallel to a direction of a magnetic flux which traverses a plane of the first end plate and the second end plate; wherein the core structure does not include a decreasing cross-sectional area near an air gap structure.

Aspect 18. The assembly according to any of the preceding aspects, wherein the core structure comprises a high permeability magnetic material having abrupt saturation characteristics in response to an increasing magnetic field from an electrical current.

Aspect 19. The assembly according to any of the preceding aspects, wherein each of the one or more central core layers further comprises: a first core member, a second core member, and a central disc member located between the first core member and the second core member; wherein the one or more central core layers comprises a channel formed between the central disc member and each of the first core member and the second core member to enable the coil member to circumferentially wind around the central disc member.

Aspect 20. The assembly according to any of the preceding aspects, wherein a planar thickness of the first portion and second portion increases from the third portion towards the distal ends of the first portion and second portion.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. An inductive device comprising:
a core structure comprising:
a first end plate located at a first side, and
a second end plate located at a second side of the core structure opposite the first side; and
wherein the first end plate and the second end plate comprise a first portion and a second portion that extend from opposing sides of a third portion, the first portion and the second portion comprising a cross-sectional area that increases from the third portion and towards distal ends of the first portion and second portion;
wherein the increasing cross-sectional area of the first portion and the second portion is configured to provide soft saturation properties in response to increasing current.

2. The inductive device of claim 1, wherein the core structure further comprises:
a central core layer disposed between the first end plate and the second end plate, the central core layer comprising:
a first core member,
a second core member, and
a central disc member located between the first core member and the second core member;
wherein the central core layer comprises a channel formed between the central disc member and each of the first core member and the second core member.

3. The inductive device of claim 2, further comprising:
a coil member located between the first end plate and the second end plate,
wherein the coil member circumferentially winds around the central disc member between the first end plate and the second end plate.

4. The inductive device of claim 1, wherein the increasing cross-sectional area is in a direction that is substantially parallel to a direction of a magnetic flux which traverses a plane of the first end plate and the second end plate.

5. The inductive device of claim 4, wherein a direction of an air gap is perpendicular to a plane of the first end plate and the second end plate;
wherein the core structure does not include a decreasing cross-sectional area near the air gap.

6. The inductive device of claim 1, wherein the core structure comprises a high permeability magnetic material having abrupt saturation characteristics in response to an increasing magnetic field from an electrical current.

7. The inductive device of claim 6, wherein the core structure comprises an abrupt saturating magnetic material comprising at least one of: ferrite, magnetic steel, nickel, cobalt, alloys thereof, or any combinations thereof.

8. The inductive device of claim 1, wherein a dimension of the third portion is configured to determine a saturation initiation point.

9. The inductive device of claim 1, wherein the first portion and second portion extend from the third portion by an angle configured to provide the increasing cross-sectional area of the first portion and the second portion.

10. The inductive device of claim 9, wherein a planar thickness of the first portion and second portion on the first end plate and the second end plate increases from the third portion towards the distal ends of the first portion and second portion.

11. A method comprising:
obtaining a high permeability magnetic material to form a core structure for an inductive device;
forming a first end plate and a second end plate,
wherein the first end plate and the second end plate comprise a first portion and a second portion that extend from opposing sides of a third portion, the first portion and the second portion comprising a cross-sectional area that increases from the third portion and towards distal ends of the first portion and second portion;
arranging the first end plate at a first side of the core structure and the second end plate at a second side of the core structure opposite the first end plate; and
arranging a coil member between the first end plate and the second end plate;
wherein the increasing cross-sectional area of the first portion and the second portion is configured to provide soft saturation properties in response to increasing current.

12. The method of claim 11, further comprising:
forming one or more central core layers; and
arranging the one or more central core layers between the first end plate and the second end plate;
wherein the coil member extends through a channel formed at each of the one or more central core layers.

13. The method of claim 12, wherein each of the one or more central core layers comprises:
a first core member,
a second core member, and
a central disc member located between the first core member and the second core member;
wherein the one or more central core layers comprises a channel formed between the central disc member and each of the first core member and the second core member to enable the coil member to circumferentially wind around the central disc member.

14. The method of claim 11, wherein a width of the third portion is configured to determine a saturation initiation point.

15. The method of claim 11, wherein a planar thickness of the first portion and second portion increases from the third portion towards the distal ends of the first portion and second portion.

16. An assembly comprising:
an inductive device comprising a core structure, the core structure comprising:
a first end plate located at a first side,
a second end plate located at a second side opposite the first side, and
one or more central core layers located between the first end plate and the second end plate;
a coil member;
wherein the first end plate and the second end plate comprise a first portion and a second portion that extend from opposing sides of a third portion, the first portion and the second portion comprising a cross-sectional area that increases from the third portion and towards distal ends of the first portion and second portion; and
wherein the increasing cross-sectional area of the first portion and the second portion is configured to provide soft saturation properties in response to increasing current;
wherein the coil member extends through the one or more central core layer from the first side towards the second side.

17. The assembly of claim 16, wherein the increasing cross-sectional area is in a direction that is substantially parallel to a direction of a magnetic flux which traverses a plane of the first end plate and the second end plate;
wherein the core structure does not include a decreasing cross-sectional area near an air gap structure.

18. The assembly of claim 16, wherein the core structure comprises a high permeability magnetic material having abrupt saturation characteristics in response to an increasing magnetic field from an electrical current.

19. The assembly of claim 16, wherein each of the one or more central core layers further comprises:
a first core member,
a second core member, and
a central disc member located between the first core member and the second core member;
wherein the one or more central core layers comprises a channel formed between the central disc member and each of the first core member and the second core member to enable the coil member to circumferentially wind around the central disc member.

20. The assembly of claim 16, wherein a planar thickness of the first portion and second portion increases from the third portion towards the distal ends of the first portion and second portion.
